(19) United States
(12) Patent Application Publication
(10) Pub. No.: US 2013/0220657 A1
(43) Pub. Date: Aug. 29, 2013

(54) HAND-OPERATED MACHINE TOOL DEVICE

(71) Applicants: Florian Esenwein, Leinfelden-Echterdingen (DE); Manfred Lutz, Filderstadt (DE); Achim Trick, Sielmingen (DE); Thomas Schomisch, Filderstadt (DE)

(72) Inventors: Florian Esenwein, Leinfelden-Echterdingen (DE); Manfred Lutz, Filderstadt (DE); Achim Trick, Sielmingen (DE); Thomas Schomisch, Filderstadt (DE)

(73) Assignee: Robert Bosch GmbH, Stuttgart (DE)

(21) Appl. No.: 13/819,189

(22) PCT Filed: Jul. 28, 2011
(86) PCT No.: PCT/EP2011/063001

§ 371 Date: May 13, 2013

(30) Foreign Application Priority Data
Aug. 26, 2010 (DE) 10 2010 039 794.6

(51) Int. Cl. B25F 5/02

(52) U.S. Cl. CPC B25F 5/02
USPC 173/170

(57) ABSTRACT

A hand-operated machine tool device, in particular for an angle grinder, includes a housing region and at least one operating element. The housing region is at least substantially rod-shaped and is configured to be used as a main gripping element. The at least one operating element extends in the housing region in a main extension direction of the housing region. The hand-operated machine tool device also has a least one mounting which supports at least one operating face of the at least one operating element such that the at least one operating element is configured to pivot about at least one axis aligned at least substantially parallel to the main extension direction.

### PRIOR ART

The invention is based on a hand power tool according to the preamble of claim 1.

There has already been proposed a hand power-tool device, in particular for an angle grinder, having an at least substantially rod-shaped housing region that, during operation, serves as a main handle element, and having at least one operating element, which extends, on the housing region, along a direction of main extent of the housing region.

### DISCLOSURE OF THE INVENTION

The invention is based on a hand power-tool device, in particular for an angle grinder, having an at least substantially rod-shaped housing region that, during operation, serves as a main handle element, and having at least one operating element, which extends, on the housing region, along a direction of main extent of the housing region.

It is proposed that the hand power-tool device has at least one bearing, by which at least one operating face of the operating element is carried so as to be swivelable about at least one axis aligned at least substantially parallelwise in relation to the direction of main extent. In particular, a “rod-shaped housing region” is to be understood to mean a region of a housing of a hand power tool having a longitudinal extent that is at least twice as long, advantageously at least three times as long, particularly advantageously at least four times as long, as a maximum transverse extent. Preferably, the rod-shaped housing region has an at least partially rounded outer face, particularly preferably an at least substantially cylindrical outer face. Preferably, the rod-shaped housing region has, in particular, a substantially round outer cross section, on at least a plane aligned perpendicularly in relation to the direction of main extent, advantageously on a greater part of a total length. Alternatively or additionally, the housing region could have one or more outer cross sections, considered appropriate by persons skilled in the art, for example polygonal and/or elliptical outer cross sections. Preferably, the outer cross section is less than 15 cm, particularly preferably less than 10 cm. In particular, one or more housing elements can constitute the rod-shaped housing region. Furthermore, the hand power-tool device could have a plurality of rod-shaped housing regions. Preferably, the rod-shaped housing region encloses at least one function element of a hand power tool, and in particular it encloses a function element of a drive train of the hand power tool such as, for example, a motor, a transmission and/or an electronics unit. The expression “during operation” is to be understood to mean, in particular, during a work operation conducted by an operator. In particular, the term “main handle element” is to be understood to mean, in particular, an element provided to be gripped by the operator, in particular during a work operation in a confined space. “Provided” is to be understood, in particular, as specially configured and/or designed. In particular, an “operating element” is to be understood to mean an element by means of which the operator influences the state of the hand power tool, advantageously a state of a motor of the hand power tool, during a work operation. Preferably, the operator influences a rotational speed of an insert tool by means of the operating element. The expression “along the housing region” is to be understood to mean, in particular, that the operating element has at least one partial face adjacent to and, in particular, separated by less than 5 mm from, the housing region. In particular, a “direction of main extent” is to be understood to mean a direction in which an element parallel to an outer contour has a maximum extent. Preferably, the housing region and/or, in particular, the operating face has a plane of symmetry aligned parallelwise in relation to the direction of main extent, over a region along the direction of main extent. Alternatively, the housing region and/or the operating face can be realized asymmetrically. A “bearing” is to be understood to be, in particular, a unit provided to exert upon the operating element a bearing force that counteracts a motion other than a swiveling motion. In particular, an “operating face” is to be understood to mean a face of the operating element upon which an operator exerts a force during an actuation. The expression “substantially parallelwise” is to be understood to mean, in particular, that an angle between the direction of main extent of the housing region and the axis is less than 30 degrees, particularly preferably less than 10 degrees. In particular, the expression “carried so as to be swivelable” is to be understood to mean that the bearing fastens the operating element such that it is rotatable about an axis, over an angular range. The design of the hand power-tool device according to the invention makes it possible to achieve comfortable operation, in particular in combination with a dead-man circuit. In particular, an actuating force and an actuating stroke of the operating element are substantially constant at differing locations along the direction of main extent of the operating element. Owing to the swivelable mounting, there is little susceptibility to jamming, this being particularly advantageous, in particular in comparison with an operating element that is moved translationally. A “dead-man circuit” is to be understood to mean, in particular, a circuit that automatically deactivates the hand tool in the case of a termination of an intended activation of the hand power tool, for example in the case of unconsciousness, and/or in the case of intentional release.

In a further design, it is proposed that the operating element has a direction of main extent aligned at least substantially parallelwise in relation to the direction of main extent of the housing region, whereby, through simple design means, particularly comfortable and safe operation can be achieved, in particular substantially irrespective of an operator hand position along the main extent.

Furthermore, it is proposed that the operating element extends over at least a greater part of a total length of the rod-shaped housing region, whereby very particularly safe and comfortable operation is made possible through simple design means. A “total length” is to be understood to mean, in particular, an extent along the direction of main extent. In particular, the expression “extend over at least a greater part of a total length” is to be understood to mean that planes aligned perpendicularly in relation to the direction of main extent intersect the housing region and the operating element on at least 50%, preferably at least 75% of the total length of the housing region.

Further, it is proposed that the operating face is realized in a convexly curved manner, enabling an operator to comfortably and reliably operate the operating means from differing sides. In particular, the operating element is equally suited for operation by left-handed and right-handed operators. Preferably, the operating face is convexly curved in at least one plane aligned perpendicularly in relation to the direction of main extent of the operating element.

Advantageously, the operating face in this plane is convexly curved on a segment of at least 10 mm, advantageously 20 mm. Preferably, the convexly curved operating face has a radius of greater than 20 mm, particularly preferably greater than 40 mm.

In addition, it is proposed that the hand power-tool device comprises an inhibiting device for inhibiting the operating element, having a release element that is provided to undo the inhibiting of the operating element, whereby particularly safe operation can be achieved, because the operating element can be inhibited against unintentional actuation, for transport and/or storage. An “inhibiting device” is to be understood to mean, in particular, a device that prevents at least a reaction to an actuating force acting upon the operating element, i.e. a force in an actuating direction. Advantageously, the inhibiting device prevents, in particular mechanically, an actuating movement of the operating element. Alternatively or additionally, the inhibiting device could interrupt an output of energy, in particular electrical energy, to a means that can be actuated by means of the operating element. For example, a switching unit could interrupt a supply of energy to the motor. Preferably, the release element differs haptically from the operating element and/or has advantageously differing actuating directions. An “actuating direction” is to be understood to mean, in particular, a direction in which the operating element is carried such that it can be moved from a non-actuated position into an actuated position.

Furthermore, it is proposed that the housing region encloses at least one free region, into which the operating element is carried such that it can be sunk, at least partially, upon an actuation, whereby, advantageously, the operating element can be operated and well protected. A “free region” is to be understood to mean, in particular, a region that is adjacent to the operating element and that, when the operating element is not actuated, is free of the operating element and, in particular, third elements. Preferably, the operating element can be actuated by being moved in the direction of the free region. In particular, “enclose” is to be understood to mean that the free region is disposed within the housing region, i.e. in particular, that the housing region encloses the free region, at least largely, on a hemisphere.

In an advantageous realization of the invention, it is proposed that the operating element, when in a non-actuated operating state, is disposed in an at least partially sunk manner in the housing region, such that the operating element is disposed in an advantageously protected manner. “Disposed in an at least partially sunk manner” is to be understood to mean, in particular, that at least 5%, advantageously at least 10% of a material of the operating element, when in a non-actuated operating state, is disposed within a face that spans a surface of the housing region, advantageously an inner face of the housing. Advantageously, at least one stop of the operating element is disposed in a sunk manner in the housing region, which stop prevents the operating element from moving completely out of the housing region. Preferably, the operating element protrudes from the housing region at a through-hole or, alternatively, at a plurality of through-holes.

In a further design, it is proposed that the bearing comprises at least one film hinge, with the result that little resource input is required for structural design and production costs are kept low. A “film hinge” is to be understood to mean, in particular, a hinge in which a flat, flexible material transmits a bearing force. Preferably, the film hinge is realized so as to be integral with the housing region and/or, advantageously, with the operating element. Preferably, the film hinge has a flexurally soft region, which transmits substantially only tensile and/or compressive forces.

Furthermore, it is proposed that the bearing has at least one oblong hole, at least for guiding the operating element, thereby enabling the operating element to move, particularly advantageously, in a guided manner. An “oblong hole” is to be understood to mean, in particular, a blind hole and/or a through opening, having a non-round, preferably elongate outer form in relation to a surrounding face.

Further, it is proposed that the operating element has at least two operating faces carried so as to be movable relative to each other, enabling an advantageous symmetry of the operating element to be achieved. Preferably, the operating faces are carried so as to be tiltable by at least 10 degrees, preferably at least 20 degrees, in relation to each other.

In addition, the invention is based on a hand power tool having a hand power-tool device, it being the case that all hand power tools considered appropriate by persons skilled in the art, such as, in particular, drills, hammer drills, saws, planes, screwdrivers, routers, sanders, multifunction tools, garden appliances and/or, advantageously, angle grinders, would be conceivable, thereby making it possible to provide a hand power tool that is particularly comfortable to use.

### DRAWING

Further advantages are given by the following description of the drawing. The drawing shows five exemplary embodiments of the invention. The drawing, the description and the claims contain numerous features in combination. Persons skilled in the art will also expediently consider the features individually and combine them to create appropriate further combinations.

In the drawing:

FIG. 1 shows a schematic representation of a hand power tool according to the invention, having a hand power-tool device, which comprises a rod-shaped housing region and an operating element,

FIG. 2 shows a perspective representation of the housing region and the operating element from FIG. 1,

FIG. 3 shows a perspective representation of a portion of the housing region and the operating element from FIG. 1,

FIG. 4 shows a sectional representation of the housing region and the operating element from FIG. 1,

FIG. 5 shows a perspective detail representation of the operating element from FIG. 1,

FIG. 6 shows a perspective sectional representation of an inhibiting device of the hand power-tool device from FIG. 1,

FIG. 7 shows a sectional representation of a locking device of the hand power tool from FIG. 1,

FIG. 8 shows a perspective representation of a second exemplary embodiment of the hand power-tool device from FIG. 1,

FIG. 9 shows a perspective representation of a portion of a housing region, an operating element and an actuation pickup of the hand power-tool device from FIG. 8,

FIG. 10 shows a sectional representation of a third exemplary embodiment of the hand power-tool device from FIG. 1,

FIG. 11 shows a sectional representation of a portion of a housing region and a motor of the hand power-tool device from FIG. 10,

FIG. 12 shows a perspective representation of a further exemplary embodiment of the locking device from FIG. 7,

FIG. 13 shows a sectional representation of a fourth exemplary embodiment of the hand power-tool device from FIG. 1, and

FIG. 14 shows a schematic, perspective representation of a fifth exemplary embodiment of the hand power-tool device from FIG. 1.

### DESCRIPTION OF THE EXEMPLARY EMBODIMENTS

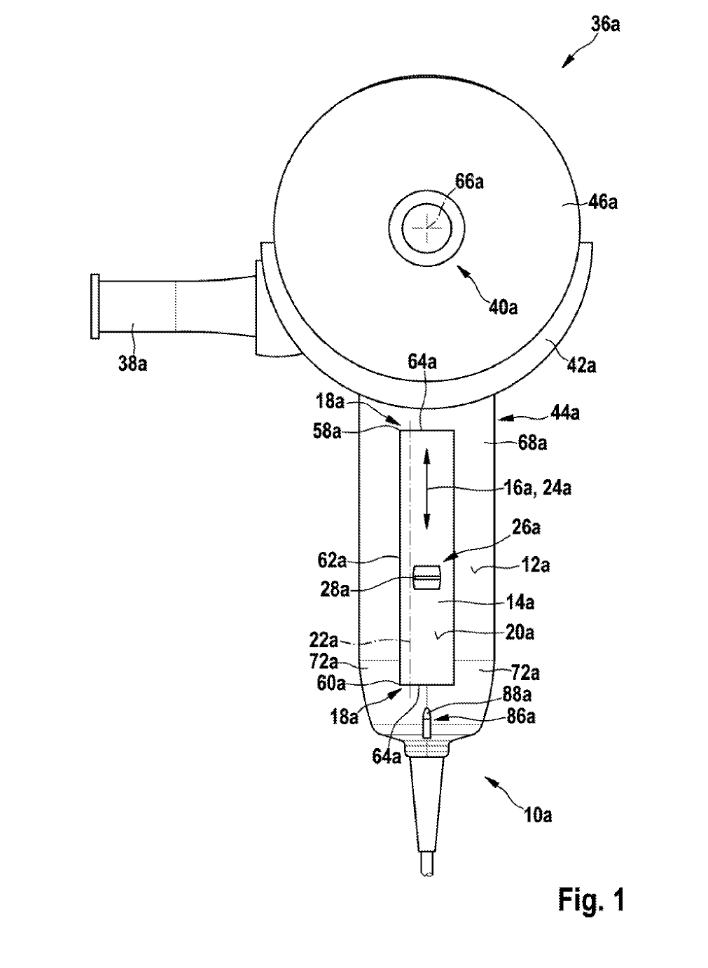

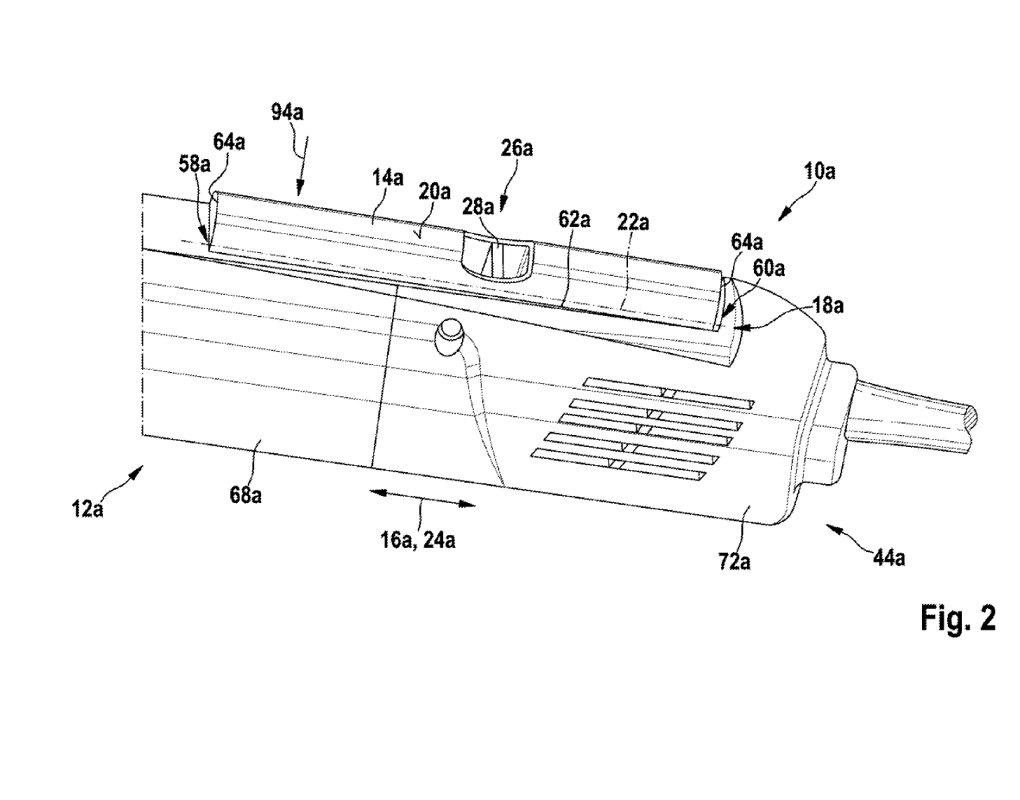

FIGS. 1 and 2 show a hand power tool 36a according to the invention having a hand power-tool device 10a. The hand power tool 36a is realized as an angle grinder. The hand power tool 36a has a weight of less than 3.5 kg, preferably less than 2.5 kg. It comprises a removable ancillary handle 38a, an insert-tool fastening 40a, an insert-tool guard 42a and a housing 44a. An insert tool 46a is fastened to the insert-tool fastening 40a.

The hand power-tool device 10a has a housing region 12a constituted by a surface of the housing 44a. The housing region 12a is realized in the shape of a rod. During operation, it serves as a main handle element. For this purpose, the housing region 12a has a roundish cross section on a plane aligned perpendicularly in relation to a direction of main extent 16a. A direction of main extent of the ancillary handle 38a is aligned substantially perpendicularly in relation to the direction of main extent 16a of the housing region 12a. The insert-tool guard 42a is disposed between the insert-tool fastening 40a and the housing region 12a. It protects an operator's hand as it grips the housing region 12a.

In addition, the hand power-tool device 10a has an operating element 14a. The operating element 14a extends on the housing region 12a, along the direction of main extent 16a of the housing region 12a, extending on a side of the housing region 12a that faces toward the insert-tool fastening 40a. Alternatively, it could also be disposed on a side of the housing region 12a that faces away from the insert-tool fastening 40a, or on another side considered appropriate by persons skilled in the art. In particular, the housing region 12a could be rotatable relative to the insert-tool fastening 40a. The operating element 14a has a direction of main extent 24a, which is aligned parallelwise in relation to the direction of main extent 16a of the housing region 12a. The operating element 14a in this case extends over at least a greater part of a total length of the rod-shaped housing region 12a. The operating element 14a has an operating face 20a having a substantially rectangular projection face. The operating face 20a is realized so as to be convexly curved about a center axis of the housing region 12a that extends along the direction of main extent 16a of the housing region 12a. Disposed between the operating element 14a and the housing 44a there is a sealing lip, not represented in greater detail, or other overlapping element, by means of which the housing 44a is protected against the ingress of dirt. The sealing lip or the overlapping element is fastened to the housing 44a.

The hand power-tool device 10a has a bearing 18a, by which the operating face 20a of the operating element 14a is carried so as to be swivelable, relative to the housing region 12a, about an axis 22a aligned parallelwise in relation to the direction of main extent 16a of the housing region 12a. For this purpose, the housing region 12a comprises a free region 30a, into which the operating element 14a is carried such that it can be partially sunk upon an actuation. The hand power-tool device 10a comprises a spring element, not represented in greater detail, which effects a force upon the operating element 14a, which force is provided to swivel the operating element 14a out of the free region 30a upon termination of an actuation. When in a non-actuated operating state, the operating element 14a is disposed so as to be at least partially sunk in the housing region 12a, at least a stop 48a of the operating element 14a being disposed in a sunk manner. The stop 48a prevents the operating element 14a from being swiveled completely out of the housing region 12a by the spring element.

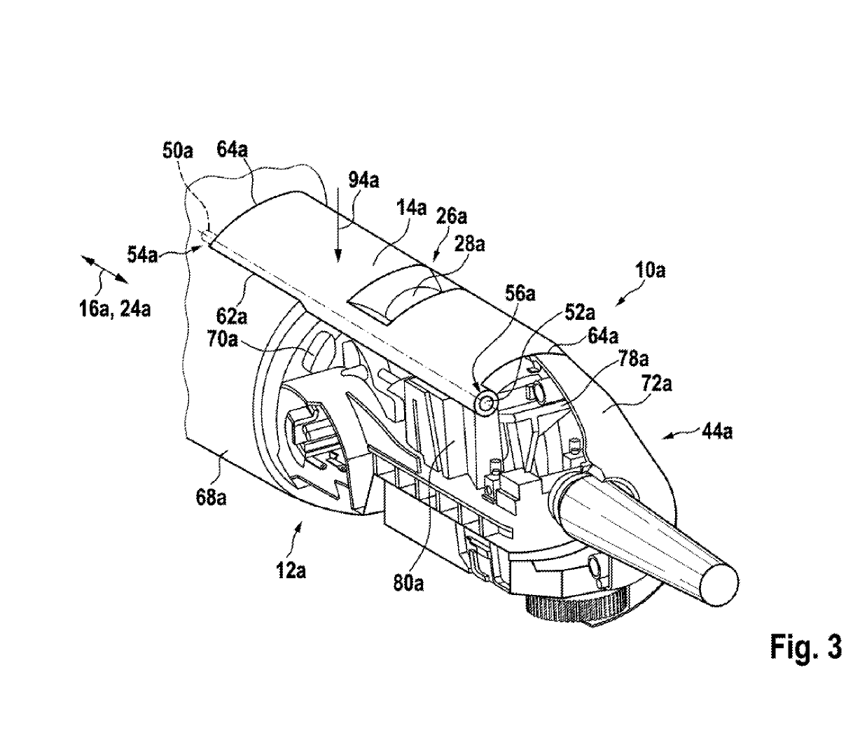

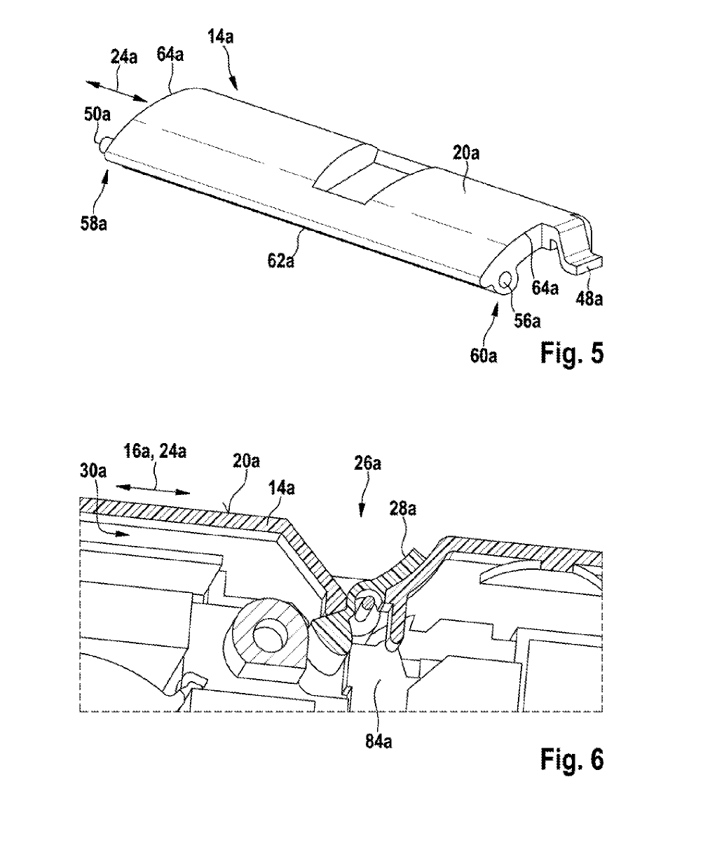

As shown by FIGS. 3, 4 and 5, the bearing 18a comprises two studs 50a, 52a and two recesses 54a, 56a. One of the studs 50a is formed on to the operating element 14a, on a corner 58a of the operating element 14a that faces toward the insert-tool fastening 40a. The associated recess 54a is formed on to the housing 44a, on a side of the housing region 12a that faces toward the insert-tool fastening 40a. The other recess 56a is formed on to the operating element 14a, on a corner 60a of the operating element 14a that faces away from the insert-tool fastening 40a. The associated stud 52a is formed on to the housing 44a, on a side of the housing region 12a that faces away from the insert-tool fastening 40a. Alternatively, studs and/or recesses of the bearing 18a could be constituted by discrete units or materials; for example, a metallic stud, in particular a steel stud, could be pressed a recess in the housing 44a and/or in the operating element 14a and carried with rotational play in the respectively other component.

The corners 58a, 60a in this case are disposed between an edge 62a of the operating element 14a that is aligned parallelwise in relation to the direction of main extent 16a and, respectively, an edge 64a that is aligned perpendicularly in relation to the direction of main extent 16a and perpendicularly in relation to a rotational axis 66a of the insert-tool fastening 40a. The two corners 58a, 60a in this case are located on the same side of the operating element 14a, as viewed in the direction of main extent 16a, it being irrelevant for operation whether the corners 58a, 60a are disposed on the left or on the right. The axis 22a of the bearing 18a is thus disposed at a distance from a plane that is spanned by the rotational axis 66a of the insert-tool fastening 40a and the direction of main extent of the housing region 12a.

During assembly, the operating element 14a is fastened by a fastening directed on to the insert-tool fastening 40a. In this case, one of the studs 50a, 52a penetrates, respectively, into one of the recesses 54a, 56a. The axis 22a of the bearing 18a extends through the two studs 50a, 52a. In addition, the bearing 18a could have further bearing elements, in particular between the studs 50a, 52a, and the recesses 54a, 56a. Alternative arrangements of the studs and recesses that are considered appropriate by persons skilled in the art are possible. Further, a film hinge between the operating element 14a and the housing 44a would be possible.

The housing 44a has a housing element 68a, which fastens a motor 70a of the hand power tool 36a. In addition, the housing 44a has a housing element 72a, which fastens an electronics unit 74a of the hand power tool 36a. This housing element 72a is realized as two shells. One shell thereof is represented in FIG. 3. The housing element 68a that fastens the motor 70a has one of the studs 52a and one of the recesses 54a. This housing element 68a therefore carries the operating element 14a. The housing element 72a that fastens the electronics unit 74a prevents the operating element 14a from moving along the direction of main extent 16a, when in an assembled state. As a result, the studs 50a, 52a are held in the recesses 54a, 56a.

The hand power-tool device 10a has an actuation pickup 76a. Upon an actuation, the actuation pickup 76a generates an electrical characteristic quantity, which contains at least information relating to the actuation. It comprises the spring element, not represented in greater detail, a lever 78a and an electrical switching component 80a. The lever 78a is carried so as to be movable about an axis 82a and, upon an actuation, converts a movement of the operating element 12a in a manner suitable for the switching component 80a.

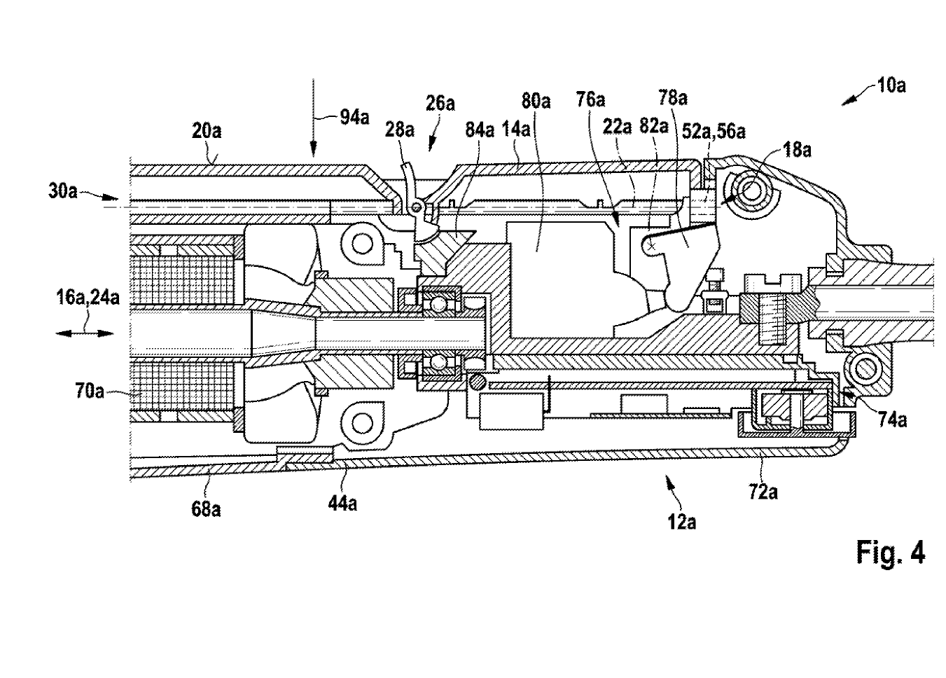

The hand power-tool device 10a has an inhibiting device 26a, which is represented in greater detail in FIGS. 4 and 6. FIG. 4 shows the the operating element 14a in a non-actuated state and the inhibiting device 26a in an inhibiting state. FIG. 6 shows the operating element 14a in an actuated state and the inhibiting device 26a in a non-inhibiting state. The inhibiting device 26a has a release element 28a and a stop 84a. The release element 28a is carried, on the operating element 14a, so as to be swivelable. It is disposed centrally on the operating element 14a. The stop 84a is formed on to the housing 44a. When the release element 28a is in an inhibiting configuration, the release element 28a supports on the housing 44a an actuating force acting upon the operating element 14a.

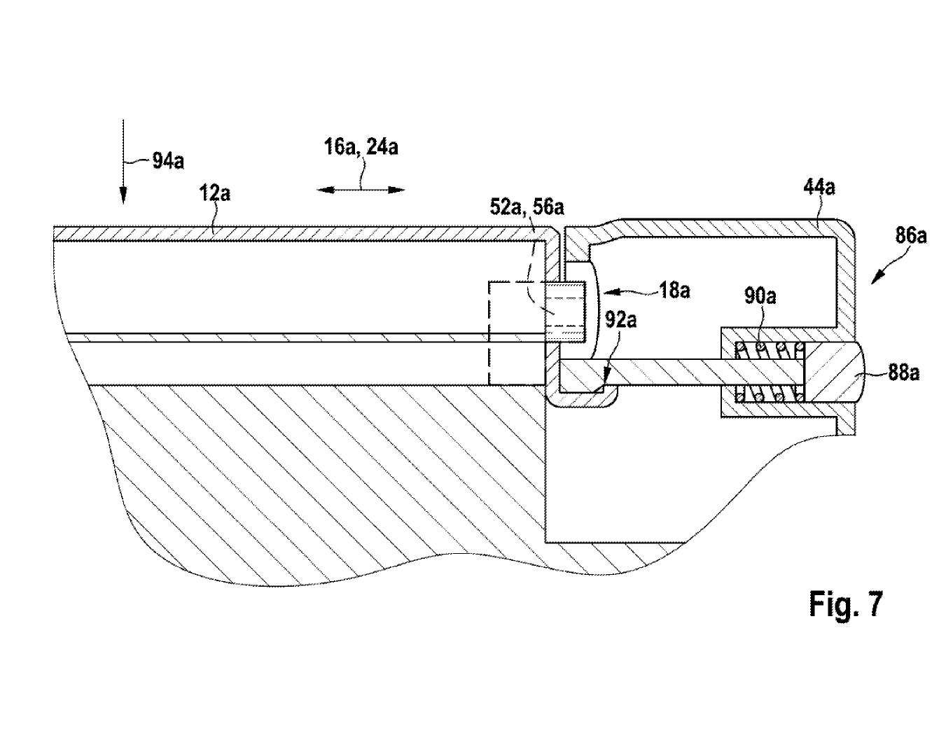

The hand power-tool device 10a comprises a switch-on locking mechanism 86a, represented only in FIGS. 1 and 7. The switch-on locking mechanism 86a has an operating means 88a, a spring element 90a and a latching means 92a. The operating means 88a is carried so as to be movable perpendicularly in relation to an actuating direction 94a of the operating element 14a. The spring element 90a effects a restoring force upon the operating means 88a. When the operator has actuated the operating element 14a, he can move the operating means 88a, against the spring element 90a, into a latching position represented in FIG. 7. In the latching position, the operating means 88a latches into the operating element 14a, by means of the latching means 92a. When in a latched-in state, the switch-on locking mechanism 86a prevents the operating element 14a from moving back into a non-actuated initial position, even if the operator does not exert any actuating force upon the operating element 14a. If the operator moves the operating element 14a, in a latched-in state, in the actuating direction 94a, the latching of the latching means 92a opens and the spring element 90a moves the operating means 88a into a non-locking position, not represented in greater detail.

During a parting operation, the operator holds the housing region 12a, advantageously by gripping with the left or the right hand, along the direction of main extent 16a, in a central region, or in a front region facing toward the insert-tool fastening 40a. The operator in this case uses either the ball of the hand or the thumb to actuate the operating element 14a. During overhead working, the operator advantageously holds the housing region 12a at a rear region that faces away from the insert-tool fastening 40a. During surface working, i.e. when the insert tool 46a is aligned approximately parallelwise in relation to a surface that is to be worked, the operator advantageously uses the tip of the finger opposite the thumb to actuate the operating element 14a.

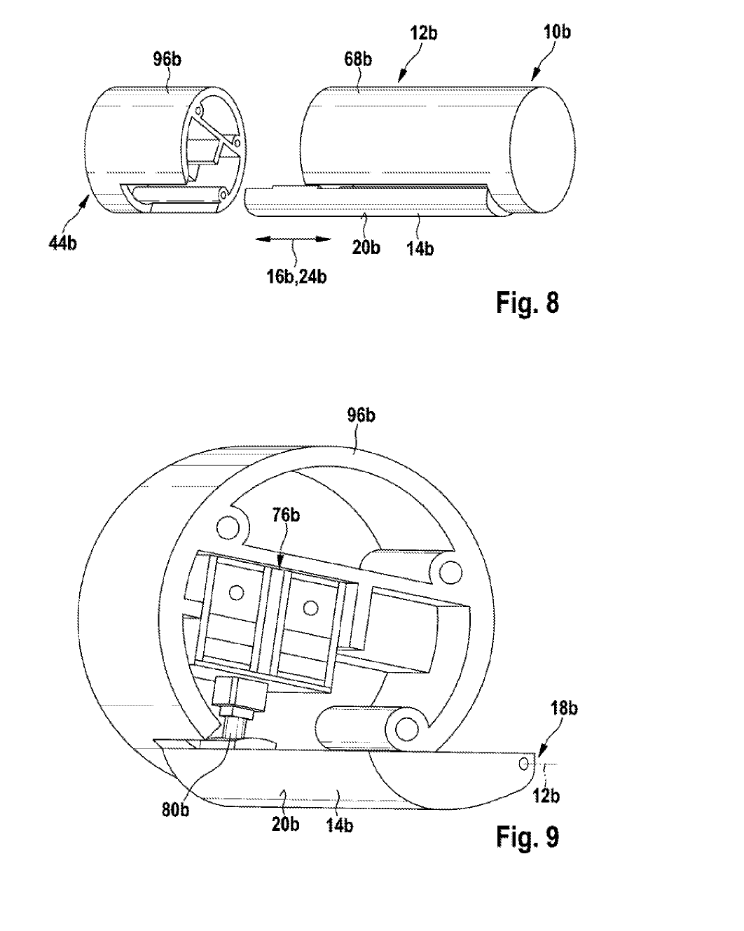

Four further exemplary embodiments of the invention are shown in FIGS. 8 to 13. The following descriptions and the drawings are limited substantially to the differences between the exemplary embodiments and, in respect of components having the same designation, in particular in respect of components having the same references, in principle reference may also be made to the drawings and/or the description of the other exemplary embodiments, in particular of FIGS. 1 to 7. In order to differentiate the exemplary embodiments, the letter a has been appended to the references of the exemplary embodiment in FIGS. 1 to 7. In the exemplary embodiments of FIGS. 8 to 13, the letter a has been replaced by the letters b to e.

FIGS. 8 and 9 show a hand power-tool device 10b having an operating element 14b and a housing 44b. The housing 44b constitutes a rod-shaped housing region 12b, which, during operation, serves as a main handle element. The housing 44b has a pot-shaped housing cover 96b, and has a housing element 68b provided to fasten a motor, not represented in greater detail. The housing 44b fastens the operating element 14b. The operating element 14b extends, on the housing region 12b, along a direction of main extent 16b of the housing region 12b. In addition, the hand power-tool device 10b has a bearing 18b. The bearing 18b carries an operating face 20b of the operating element 14b so that it can swivel about an axis 22b aligned parallelwise in relation to the direction of main extent 16b. As an alternative to the pot-shaped housing cover 96b, the operating element 14b could also be carried in a housing element, not represented in greater detail, provided to fasten a transmission.

The hand power-tool device 10b comprises an actuation pickup 76b having a switching component 80b. The actuation pickup 76b is provided to directly actuate the switching component 80b upon a movement of the operating element 14b in the actuating direction 94b.

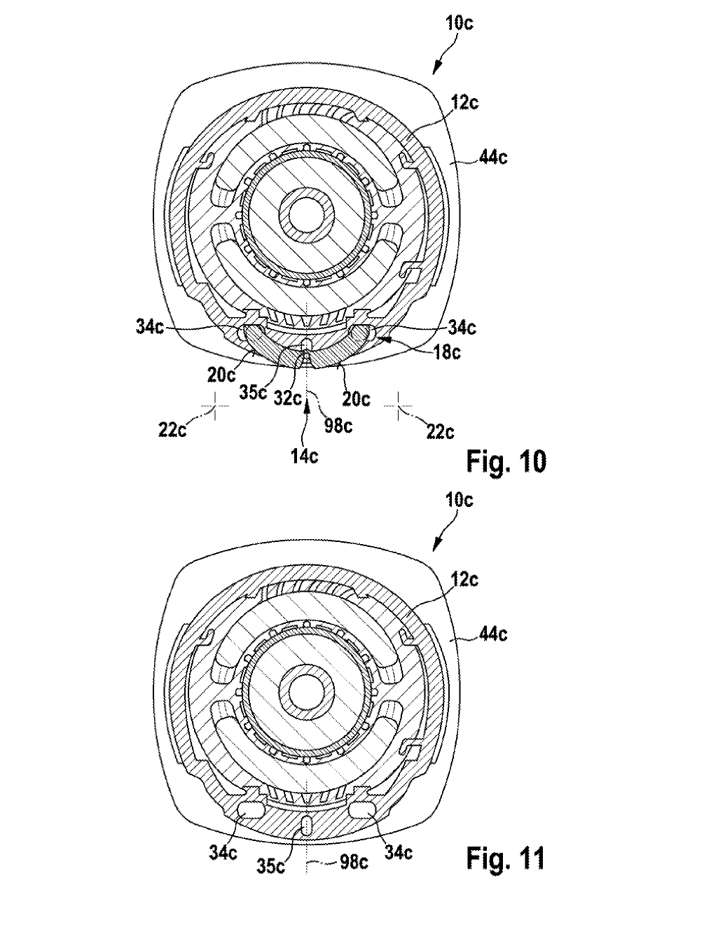

FIGS. 10 and 11 show a partial section of a hand power-tool device 10c of a hand power tool having a rod-shaped housing region 12c, an operating element 14c and a bearing 18c. During operation, the housing region 12c serves as a main handle element. The operating element 14c extends, on the housing region 12c, along a direction of main extent 16c of the housing region 12c. It has two operating faces 20c. The bearing 18c carries the operating face 20c of the operating element 14c so that it can be swiveled and in addition tilted, respectively, about an axis 22c aligned parallelwise in relation to the direction of main extent 16c. The axes 22c are disposed at a distance from the hand power-tool device 10c.

The bearing 18c has oblong holes 34c, 35c for the purpose of guiding the operating element 14c. The oblong holes 34c, 35c are disposed on a housing 44c of the hand power tool, being disposed on two sides of a free region 30c of the housing 44c, a represented side facing toward an insert-tool fastening of the hand power tool, and a non-represented side facing away from the insert-tool fastening. Two of the represented oblong holes 34c are disposed in a mirror-symmetrical manner in relation to a symmetry plane 98c that extends through the third oblong hole 35c represented. These two oblong holes 34c guide, respectively, one of the two operating faces 20c substantially perpendicularly in relation to the symmetry plane 98c. The third oblong hole guides both operating faces 20c equally in a direction parallel to the symmetry plane 98c. The bearing has a film hinge 32c, which carries the two operating faces 20c of the operating element 14c movably in relation to each other. It is possible to have between the operating faces 20c an alternatively realized bearing, considered appropriate by persons skilled in the art.

FIG. 11 shows a further exemplary embodiment of a switch-on locking mechanism 86d of a hand power-tool device 10d having an operating element 14d. The switch-on locking mechanism 86d has an operating means 88d, a spring element 90d and a latching means 92d. The operating means 88d is carried so as to be movable about an axis 100d, which is aligned perpendicularly in relation to the axis 22d of the operating element 14d. The spring element 90d effects a restoring force upon the operating means 88d. When the operator has actuated the operating element 14d, he can move the operating means 88d of the switch-on locking mechanism 86d, against the spring element 90d, into a latching position.

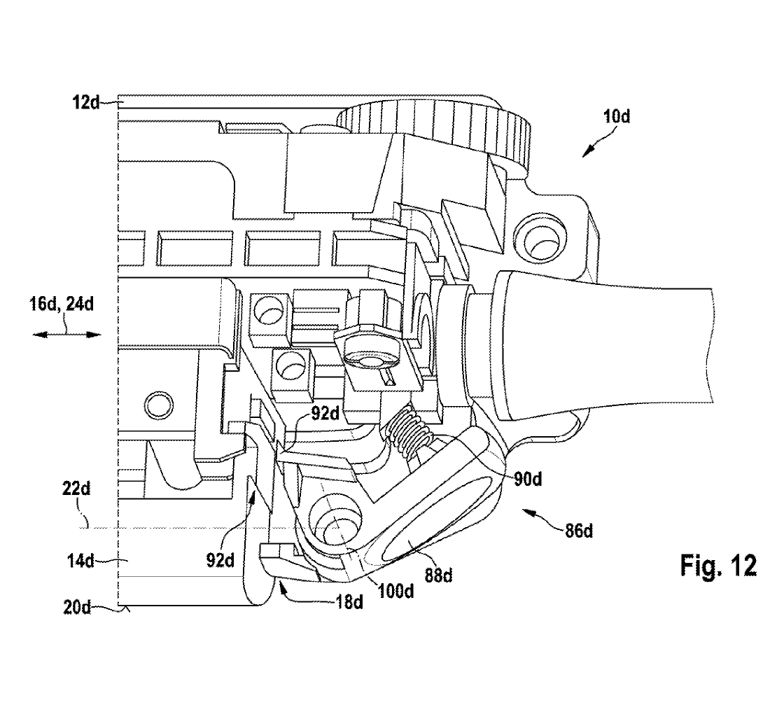

FIG. 12 shows a further exemplary embodiment of a hand power-tool device 10e, having an operating element 14e, which has two operating faces 20e that are carried movably in relation to each other. The two operating faces 20e are mounted such that they can be swiveled, respectively, about an axis 22e. One of the operating faces 20e has an opening 102e, into which a portion of another of the operating faces 20e can be sunk upon an actuation of the operating element 14e.

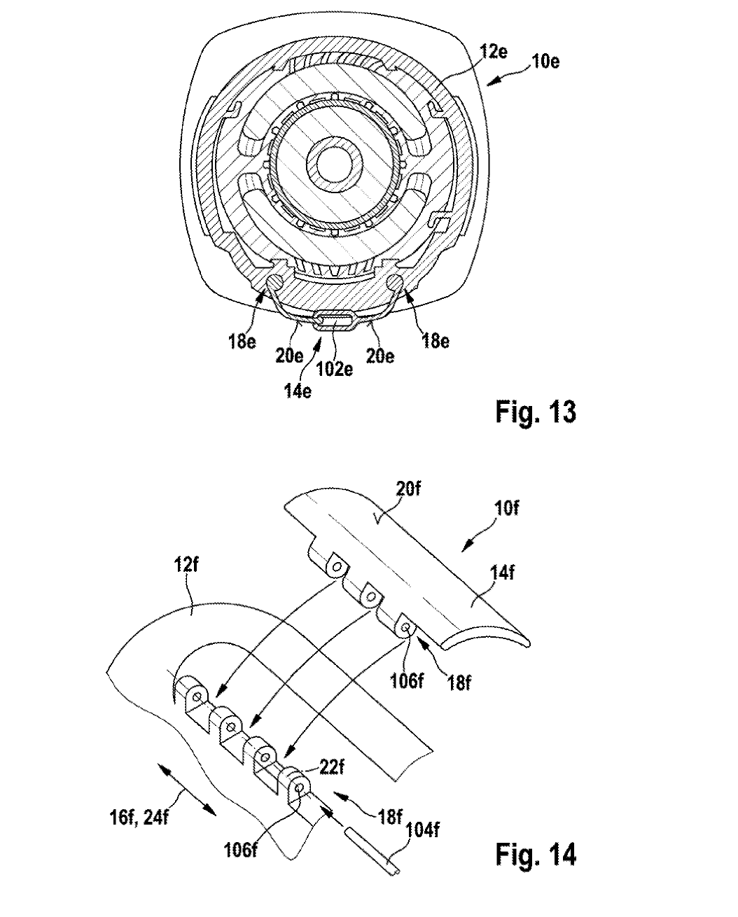

FIG. 13, in an exploded representation, shows a further exemplary embodiment of a hand power-tool device 10f, having a rod-shaped housing region 12f, an operating element 14f and a bearing 18f. The bearing 18f has a rod 104f, which extends along an axis 22f of the bearing 18f. The housing region 12f and the operating element 14f have openings 106f, through which the rod 104f extends when in an assembled operating state. The rod 104f in this case carries the operating element 14f such that it can be swiveled relative to the housing region 12f.

1. A hand power-tool device comprising:
an at least substantially rod-shaped housing region configured to serve as a main handle element during operation of the device;
at least one operating element configured to extend on the housing region along a direction of main extent of the housing region; and
at least one bearing configured to carry at least one operating face of the at least one operating element such that the at least one operating element is swivelable about at least one axis aligned at least substantially parallel to the direction of main extent of the housing region.

2. The hand power-tool device as claimed in claim 1, wherein the at least one operating element has a direction of main extent aligned at least substantially parallel to the direction of main extent of the housing region.

3. The hand power-tool device as claimed in claim 1, wherein the at least one operating element is configured to extend over at least a greater part of a total length of the housing region.

4. The hand power-tool device as claimed in claim 1, wherein the at least one operating face is convexly curved.

5. The hand power-tool device as claimed in claim 1, further comprising:
an inhibiting device configured to inhibit the at least one operating element, the inhibiting device having a release element configured to uninhibit the at least one operating element.

6. The hand power-tool device as claimed in claim 1, wherein:
the housing region is configured to enclose at least one free region, and
the at least one operating element is configured to be carried into the at least one free region so as to be sunk, at least partially, upon an actuation.

7. The hand power-tool device as claimed in claim 1, wherein the at least one operating element, when in a non-actuated operating state, is configured to be disposed in an at least partially sunk manner in the housing region.

8. The hand power-tool device as claimed in claim 1, wherein the at least one bearing includes at least one film hinge.

9. The hand power-tool device as claimed in claim 1, wherein the at least one bearing has at least one oblong hole configured at least to guide the at least one operating element.

10. The hand power-tool device as claimed in claim 1, wherein the at least one operating element has at least two operating faces configured to be carried so as to be movable relative to each other.

11. A hand power tool comprising:
a hand power-tool device including:
an at least substantially rod-shaped housing region configured to serve as a main handle element during operation of the device;
at least one operating element configured to extend on the housing region along a direction of main extent of the housing region; and
at least one bearing configured to carry at least one operating face of the at least one operating element such that the at least one operating element is swivelable about at least one axis aligned at least substantially parallel to the direction of main extent of the housing region.
